(19) United States
(12) Patent Application Publication
(10) Pub. No.: US 2016/0327730 A1
(43) Pub. Date: Nov. 10, 2016

(54) METHOD FOR RAPIDLY MANUFACTURING A LIGHT GUIDE, AND RESULTING LIGHT GUIDE AND APPARATUS

(71) Applicant: GB DEVELOPPEMENT, Puteaux (FR)

(72) Inventor: Guillaume Boulais, Levallois Perret (FR)

(73) Assignee: GB Developpement, Puteaux (FR)

(21) Appl. No.: 15/030,047

(22) PCT Filed: Oct. 16, 2014
(86) PCT No.: PCT/EP2014/072261

§ 371 Date: Jul. 18, 2016

(30) Foreign Application Priority Data
Oct. 16, 2013 (FR) 1360044

(51) Int. Cl. F21V 8/00; B29D 11/00

(52) U.S. Cl. CPC G02B 6/0065; G02B 6/0083; G02B 6/0068; G02B 6/0031; G02B 6/0091; G02B 6/0021; B29D 11/00663; B29D 11/00875; B29K 2033/12

(57) ABSTRACT

The present invention relates to a method for manufacturing a light guide in a mold, including a first plate with at least one array of ferromagnetic elements. At least one strip of sources is provided, each strip of sources including a circuit that is equipped with ferromagnetic elements and light sources, each strip being associated with an array among the at least one array of ferromagnetic elements of the first plate, each strip of sources being arranged such that each ferromagnetic element of a strip is attached to the first plate by magnetization with a ferromagnetic element of the array associated with said strip; and a coating material (33) is provided, which is initially fluid so that said fluid material coats the strips of sources. The coating material is then solidified.

### TECHNICAL FIELD

The present invention relates to a method for manufacturing a light guide. It also relates to a method for manufacturing an apparatus comprising such a light guide.

Such a method enables a user to manufacture a light guide reliably, rapidly, and cost effectively.

### PRIOR ART

A light guide is typically a plate of transparent material intended to be positioned between:
Light sources, and
An object to illuminate or backlight (such as a PC screen or a cell phone screen, a billboard, a light module, etc.).

This plate is provided for transporting and diffusing (preferably as homogeneously as possible) the light coming from these sources towards the object to be illuminated or backlit.

Methods for manufacturing a light guide are known to the prior art. For example (see French Patent #2 960 069 B1, for example), it is possible to:
Manufacture, by extrusion, a plate of transparent material comprising grooves, then
Position a light source strip in each groove, then
Finish by filling each groove, for example with PMMA.

Such a method requires a considerable amount of steps, labor, and specialized material and therefore may be time-consuming and/or expensive to implement.

Furthermore, it may not always be possible to position each light source strip in its groove in a precise, reliable manner given the fact that the width of the groove is greater than the width of the light source strip.

Lastly, obtaining the most homogeneous luminosity possible is generally problematic.

The problem addressed by the invention is that of proposing a method for manufacturing a light guide that confers at least one of the following technical advantages over the prior art:
faster, and/or
less expensive, and/or
more reliable, and/or
improvement of the homogeneity of the diffusion of the light outside the guide.

### DISCLOSURE OF THE INVENTION

This problem is solved with a method for manufacturing a light guide by casting, comprising a coating of at least one, preferably a plurality of, light source strip(s) with initially fluid (i.e., liquid, gelatinous, or pasty but neither gaseous nor solid) coating material, then solidification of the coating material.

According to a first aspect of the method according to the invention, the casting can be effected in a mold that comprises:
a first plate, which is provided with at least one, preferably a plurality of, array(s) of ferromagnetic elements, each ferromagnetic element array comprising a plurality of ferromagnetic elements aligned along a line,
and optionally a second plate,

a method wherein:
on the first plate (preferably between the two plates if the second plate is present) are disposed:
   the at least one, preferably a plurality of, light source strip(s), each light source strip comprising a circuit equipped with ferromagnetic securing elements and light sources, each strip being associated with an array among the at least one ferromagnetic element array of the first plate, each light source strip being disposed in such a way that each ferromagnetic securing element is magnetically secured on the first plate with a ferromagnetic element of the array associated with this strip,
   the initially fluid coating material, in such a way that said fluid material coats the light source strips,
the coating material is then solidified.

The at least one light source strip can comprise at least one light source strip disposed in such a way that the light sources thereof are located between the circuit thereof and the first plate.

The at least one light source strip can comprise at least one light source strip disposed in such a way that the ferromagnetic elements thereof are located between the circuit thereof and the first plate.

The at least one light source strip can comprise at least one light source strip provided with a reflector arranged for reflecting light towards the first plate.

If the second plate is present, the at least one light source strip can comprise at least one light source strip disposed in such a way that the circuit thereof is located in a plane that is closer, preferably at least three times closer, to the first plate than to the second plate.

Ferromagnetic elements of the first plate can be housed in the thickness of said first plate. In this case, ferromagnetic elements of the first plate can each be housed in the thickness of said first plate by means of a tightening ring.

The first plate can comprise a first surface in contact with the coating material while the latter is solidifying and a second surface opposite the first surface, and ferromagnetic elements of the first plate can be located on the second surface of said first plate.

The ferromagnetic elements of the first plate are preferably magnets, for example permanently magnetized magnets or electromagnets.

The ferromagnetic elements of the at least one light source strip are preferably not magnets.

The at least one array of ferromagnetic elements can comprise at least one array of ferromagnetic elements that are aligned along a straight line.

The at least one array of ferromagnetic elements can comprise a plurality of arrays aligned along parallel lines.

According to a second aspect of the invention, which is conceivable alone or in combination with the first aspect of the method according to the invention, the casting (between two plates, or on one plate, or by injection, or by extrusion, or by continuous casting) can be arranged for obtaining, after the coating material solidifies, a light guide comprising the coating material coating the at least one light source strip in such a way that for each given light source strip, starting from:
the projection of said strip on a first surface of the light guide, and
in a direction of progression perpendicular to the elongation of this strip,
   a surface density (preferably equal to one initially) of sunken patterns on said first surface of said light guide decreases progressively per unit area up to a certain limit distance, this limit distance being preferably equal to half of the distance separating this given strip from its neighboring strip on the side of this direction of progression. A film or any other reflective surface can then be glued onto the first surface of the light guide in such a way that said film or said reflective surface is only in contact with the non-sunken portions of the first surface of the guide.

In the case where the casting is effected in a mold comprising a first plate, the first plate can be provided with sunken patterns, these patterns being in contact with the coating material as it solidifies. In the case where this first plate corresponds to the first plate of the first aspect of the method according to the invention, for each given ferromagnetic element array of the first plate, starting from:
the projection of said array on the surface of the first plate provided with sunken patterns, and
in a direction of progression,
   the surface density (preferably zero initially) of the sunken patterns on the first plate preferably increases progressively per unit area up to a certain limit distance, this limit distance preferably being equal to half of the distance separating this given array from its neighboring array on the side of this direction of progression.

In the case where this first plate corresponds to the first plate of the first aspect of the method according to the invention, after the solidification of the coating material, it is possible to obtain a light guide comprising the coating material coating the at least one light source strip, said light guide comprising a first surface in contact with the first plate (and optionally a second surface in contact with the second plate if this second plate is present), and this light guide is removed from the mold (preferably by extracting it from between the two plates if the second plate is present).

After removal from the mold, a film or a reflective surface can be glued onto the first surface of the light guide in such a way that said film or said reflective surface is only in contact with those portions of the first surface of the guide that are formed during the solidification of the coating material in the sunken patterns in the first plate.

Furthermore, the concept of this second aspect of the invention for manufacturing a light guide can be generalized by not limiting it to a casting or to a coating of at least one light source strip.

According to a third aspect of the invention, a method for manufacturing a light guide is thus defined, said method comprising:

A) preparation or provision of a light guide comprising at least one, preferably a plurality of, light source strip(s) (not necessarily coated without an air space and/or not necessarily in the thickness of a plate of the light guide), the light guide having the shape of a plate comprising two opposite surfaces, of which one is a first surface, wherein
B) a reflective surface is secured on said first surface of the light guide such that for each given light source strip, starting from:

the projection of said strip on the first surface of the light guide, and

in a direction of progression perpendicular to said strip,

the density of the contact surface (preferably initially zero at this given strip) between the reflective surface and the first surface of the guide increases progressively per unit area up to a certain limit distance, this limit distance preferably being equal to half of the distance separating this given strip from its neighboring strip on the side of this direction of progression (if this given strip in fact has a neighboring strip on the side of this direction of progression).

In order for the contact surface between the reflective surface and the first surface of the guide to progress in this manner, it is possible to:

provide the first surface of the light guide with sunken patterns that will not be in contact with the reflective surface after the attachment of said reflective surface; for example, these patterns can be made by casting as disclosed above, but they can also be made by etching the first surface of the guide, or by depositing a (transparent) resin on the first surface of the light guide for constructing the edges of the sunken patterns; these patterns can also arise due to a particle size distribution of the first surface, wherein this particle size distribution can be obtained, for example, by chemically treating this surface; and/or

selectively spread glue (typically by material jetting, according to the same principle as an inkjet of a printer, or by screen printing) only on certain areas of the first surface of the guide and/or on certain areas of the reflective surface in such a way that, after attaching said reflective surface:
all portions of the first surface of the guide and of the reflective surface that are bonded together by glue are part of the contact surface between the reflective surface and the first surface of the guide
but certain portions of the first surface of the guide and of the reflective surface that are not bonded together by glue (and that are preferably separated by air) are not part of this contact surface; and/or

construct welds, typically “point” or “spot” welds of a certain diameter or a certain width, respectively, for example by laser welding, between the first surface of the guide and the reflective surface such that, after attaching the reflective surface:
all portions of the first surface of the guide and of the reflective surface that are bonded together by welding are part of the contact surface between the reflective surface and the first surface of the guide
but certain portions of the first surface of the guide and of the reflective surface that are not bonded together by welding (and preferably separated by air) are not part of this contact surface.
   When light emitted by the sources and circulating in the light guide:
encounters a point with contact between the reflective surface and the first surface of the guide, said light tends to exit the guide, or
encounters a point without contact between the reflective surface and the first surface of the guide (in other words, preferably with an air space between the reflective surface and the first surface of the guide), said light tends to continue on its path in the guide. This method makes it possible:
to effectively control the exit of the light from the guide relative to the position of the light sources for a homogeneous light distribution, and
to render the reflective surface integral with the light guide for a sturdier and better-sealed product.

According to another special feature of the invention, a method is proposed for manufacturing an apparatus, a method wherein a light guide according to the invention is manufactured, characterized in that said light guide is integrated in the apparatus.

According to another special feature of the invention, a light guide or an apparatus is proposed, wherein said light guide or said apparatus is obtained by one of the methods for manufacturing guides or apparatuses according to the invention.

It should be noted that this entire presentation of the invention can be generalized, without exceeding the scope of the invention:
by replacing each (or only a portion) of the ferromagnetic elements of the first plate with a connecting element comprising, for example, clipping or interlocking means or any other mechanical connection means, and
by replacing each (or only a portion) of the ferromagnetic securing elements with a securing element comprising, for example, clipping or interlocking means or any other mechanical means of forming a complementary connection with a connecting element of the first plate,
   such that each securing element of a given strip is secured (for example mechanically, for example by clipping or interlocking) on the first plate with a connecting element of the array associated with said strip.

In a manner possibly combinable with the preceding generalization, it should be noted that this entire presentation of the invention can be generalized, without exceeding the scope of the invention:
by replacing each (or only a portion) of the arrays of connecting elements with a group of connecting elements that are not necessary aligned, and/or
by replacing each (or only a portion) of the light source strips with a light source sheet that does not necessarily have an elongate strip-like shape, but the shape of a disc, for example, and/or
each light source sheet or strip can comprise a circuit that is equipped with at least one securing element and at least one light source, i.e., in a minimum version equipped with a single securing element and/or a single light source, and/or
each group of connecting elements can comprise at least one connecting element, i.e., a single connecting element in a minimum version.

### DESCRIPTION OF THE FIGURES AND EMBODIMENTS

Other advantages and special features of the invention will emerge upon studying the detailed description of non-limiting implementations and embodiments, and of the following appended drawings:

FIG. 1 is a cutaway profile view of a mold 1 in which a light guide is manufactured according to a first embodiment of the method according to the invention,

FIG. 2 is a perspective view of a first plate 11 of the mold 1 of FIG. 1, the cutting plane of FIG. 1 corresponding to a plane perpendicular to all of the straight lines 15 that are represented in FIG. 2,

FIG. 3 is a perspective view of one of the light source strips 7 illustrated in profile in FIG. 1,

FIG. 4 is a magnified view of the detail 31 of FIG. 3,

FIG. 5 is a magnified view of the detail 32 of FIG. 2, for a first variant of sunken patterns 51 on the plate 11,

FIG. 6 is a magnified view of the detail 34 of FIG. 2, for a second variant of sunken patterns 51 on the plate 11,

FIG. 7 is a magnified view of the detail 35 of FIG. 2, for a third variant of sunken patterns 51 on the plate 11,

FIG. 8 is a perspective view of a portion of the light guide obtained in the case of the first variant of sunken patterns on the plate 11,

FIG. 9 is a magnified view of the detail 36 of FIG. 9, cut along the cut 37 of FIG. 8,

FIG. 10 is a perspective view of a portion of the light guide obtained in the case of the second variant of sunken patterns on the plate 11,

FIG. 11 is a perspective view of a portion of the light guide obtained in the case of the third variant of sunken patterns on the plate 11,

FIG. 12 is a magnified view of the detail 38 of FIG. 11, cut along the cut 39 of FIG. 11,

FIG. 13 is a perspective view of a variant of the first plate 11, used in a second embodiment of the method according to the invention, and

FIG. 14 is a magnified view of the detail 40 of FIG. 1,

FIGS. 15 through 17 illustrate different variants of the invention, and

FIG. 18 illustrates a variant of the preceding variants and preceding embodiments.

As these embodiments are not limiting in any way, one can therefore imagine including variants of the invention including only a selection of features described subsequently isolated from other features described (even if this selection is isolated within a sentence comprising these other features), if this selection of features is sufficient to confer a technical advantage or to distinguish the invention over the prior art. This selection includes at least one preferentially functional feature without structural details, or with only some structural details if this part only is sufficient to confer a technical advantage or to distinguish the invention over the prior art.

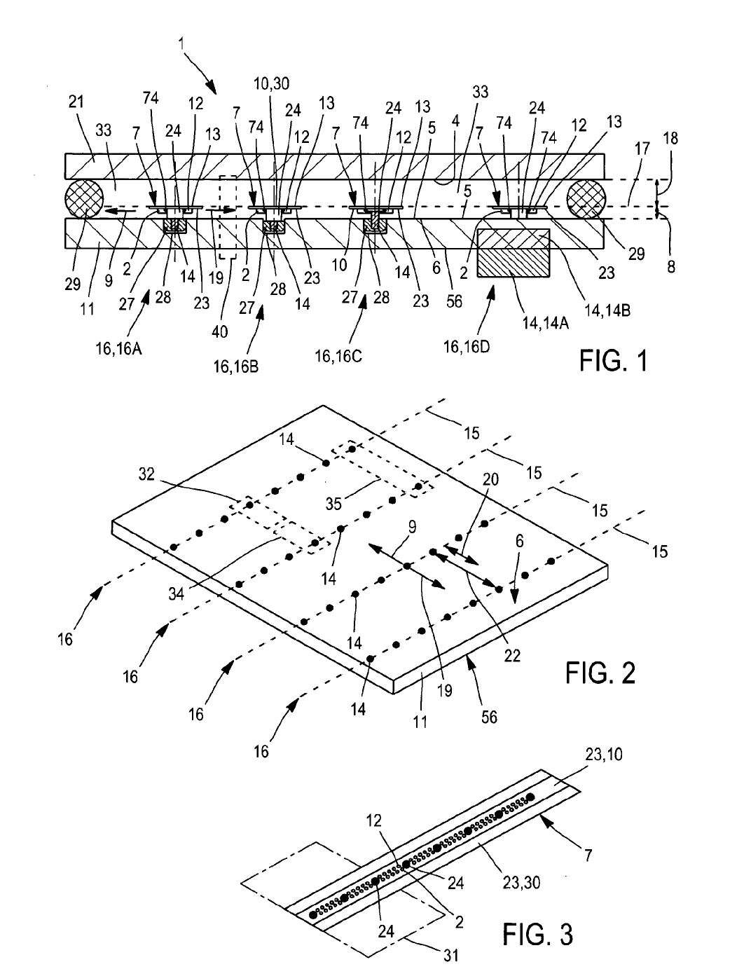

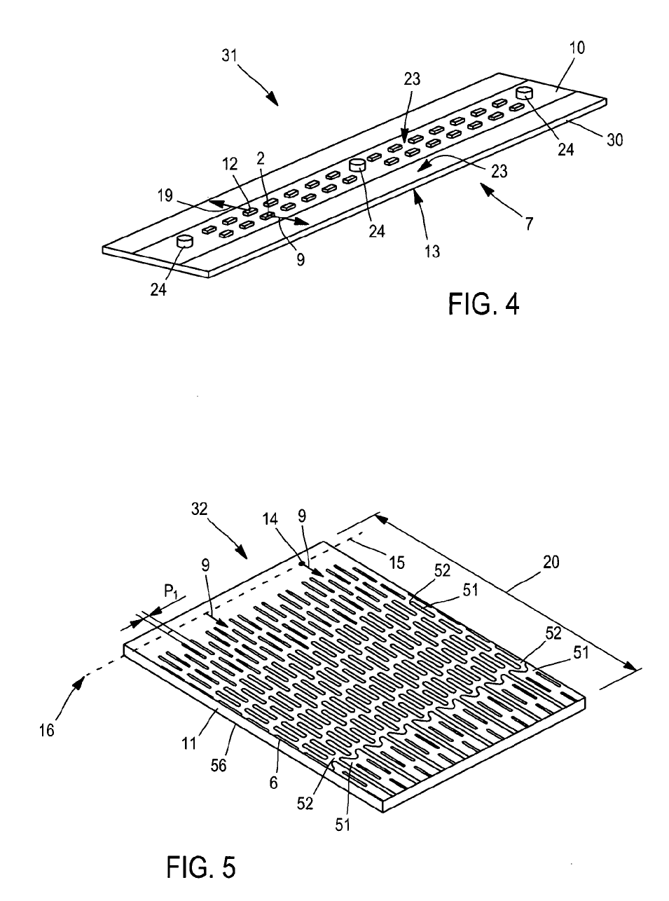

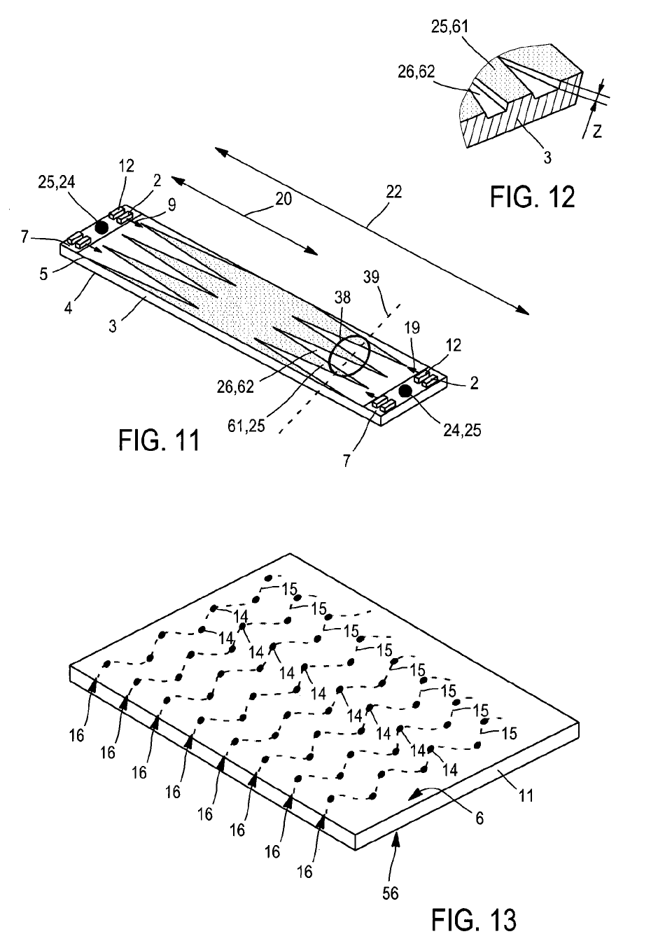

A first embodiment of the method according to the invention shall now be described, with reference to FIGS. 1 through 12 and 14.

As illustrated in FIG. 1, in a first embodiment of the method for manufacturing a light guide 3 according to the invention, a light guide 3 is manufactured in a mold 1.

The mold 1 comprises a first plate 11 and a second plate 21.

The first plate 11 is provided with at least one, preferably a plurality of, array(s) 16 of ferromagnetic elements 14. Each ferromagnetic element array 16 comprises several ferromagnetic elements 14 aligned along a line 15 distinct from the line 15 of the other arrays. The ferromagnetic elements 14 are uniformly spaced along a line 15. The distance between two ferromagnetic elements 14 along a line 15 is typically between 5 and 30 centimeters.

In this document, “each” is used to designate any unit considered individually in a whole. In the case where this whole comprises at least one unit, there is thus a limiting case where the whole comprises a single unit and where the word “each” designates this single unit.

“Element array/array of elements” is generally understood to mean elements located on the same line, which does not necessarily have to be a straight line.

In the specific case of FIG. 1, the at least one array 16 of ferromagnetic elements 14 comprises at least one array 16 of ferromagnetic elements 14 aligned along a straight line 15.

In the specific case of FIG. 1, the at least one array 16 of ferromagnetic elements 14 comprises a plurality of arrays 16 aligned along parallel lines 15.

The first plate 11 is made of transparent material (for example glass or Schott® borosilicate) or of metal (for example aluminum or stainless steel). In the preferred variant, the first plate 11 is made of metal (preferably aluminum or stainless steel) to facilitate the machining thereof, specifically the etching of patterns 51.

The second plate 21 is disposed essentially parallel to the first plate 11. The second plate 21 is made of transparent material (for example tempered glass) or of metal (for example aluminum or stainless steel). In the preferred variant, the second plate 21 is made of transparent material (preferably glass) to allow an operator to check the fullness of the intermediate space delimited between the two plates 11, 21 with material 33.

In the first embodiment of the method according to the invention, at least one, preferably a plurality of, strip(s) 7 of light sources 2, 12 is/are disposed between the two plates 11, 21.

Each light source strip 7 comprises a printed circuit 10 (for example a “Flex PCB” flexible printed circuit (typically on PEEK (polyetheretherketone) film) or an FR-4 (Flame Resistant 4) printed circuit) with a thickness typically between 0.1 and 1 mm, for example 0.5 mm, and equipped with, on the same side:
ferromagnetic securing elements 24 (in the shape of a cylinder or a rectangular parallelepiped 2 to 4 mm in diameter or width and between 1 and 5 mm in height) preferably welded onto the circuit 10 by one or a plurality of welds 74; and
light sources 2, 12 (typically light-emitting diodes or LEDs, for example NICHIA NNSW206CT), including a first row of light sources 2 that are arranged for emitting light in a direction 9, and a second row of light sources 12 that are arranged (parallel to the first row) for emitting light in a direction 19 (opposite the direction 9). The light sources or LEDS 2, 12 are light sources known to persons skilled in the art under the name “side views”, i.e., they are positioned for emitting light in a direction 9, 19 parallel to the circuit 10 that is equipped with them.

Each light source 2, 12 and each element 24 of a given strip 7 is located on the same side of the circuit 10 of said strip 7.

Each strip 7 is associated with an array 16 among the at least one array 16 of ferromagnetic elements 14 of the first plate 11, each strip 7 of light sources 2, 12 being disposed in such a way that each ferromagnetic element 24 of a strip 7 is magnetically secured on the first plate 11 with a ferromagnetic element 14 of the array 16 associated with said strip 7.

Hence for each pair of a ferromagnetic element 14 and a ferromagnetic element 24 secured together, at least one ferromagnetic element 14 and/or 24 is a magnet (for example an electromagnet or a permanent, preferably neodymium magnet). Thus for each pair of a ferromagnetic element 14 and a ferromagnetic element 24 secured together, there are:
the ferromagnetic element 14, which is a magnet (for example an electromagnet or a permanent magnet), and the other ferromagnetic element 24, which comprises a non-magnetized ferromagnetic material (iron, for example). This ferromagnetic element 24 is nickel-plated or tin-plated so that it can be welded to its circuit 10; or
the ferromagnetic element 24, which is a magnet (for example an electromagnet or a permanent magnet), and the other ferromagnetic element 14, which comprises a non-magnetized ferromagnetic material (iron, for example), or
each of the two ferromagnetic elements 14 and 24 is a magnet (for example an electromagnet or a permanent magnet), the two ferromagnetic elements 14 and 24 being magnets with opposite polarities facing one another.

It should be noted that only four arrays 16 are shown in FIGS. 1 and 2 so as not to overcrowd these figures. In reality there can be many more arrays. Typically, the width (in the plane of FIG. 1, and parallel to the plane 17) of each of the strips 7 is between 5 mm and 12 mm, the distance (in the plane of FIG. 1, and parallel to the plane 17) separating two neighboring arrays 16 or two neighboring strips 7 is between 5 cm and 50 cm, the width (in the plane of FIG. 1, and parallel to the plane 17) of each of the plates 11 and 21 is between 20 cm and 3 m, and hence there are typically between 1 and 60 arrays 16.

Furthermore, preferably after having magnetically secured the strips 7 to the plate 11, initially fluid coating material 33 (which can be, for example, PMMA, acrylic, polyester, silicone, or epoxy, preferably with an anti-stick treatment such as a polytetrafluoroethylene or alumina coating of each plate of the mold) is disposed between the two plates 11 and 21 in such a way that this fluid material 33 coats the strips 7 of light sources 2, 12. To this end, the two plates 11, 21 delimit an intermediate space to fill with the material 33. The periphery of this intermediate space is delimited by a gasket 29 (typically a PVC gasket) in order to form a seal. The gasket 29 is provided with an orifice (not illustrated) for pouring the material 33 into the intermediate space. As this intermediate space is being filled with the material 33, the mold 1 is tilted in such a way that this orifice is at the top.

Lastly, the coating material 33 is solidified (for PMMA, polymerization at 60° C. for 6 hours, then post-polymerization at 120° C. for 1.5 hours), wherein:
each ferromagnetic element 24 of a strip 7 is magnetically secured on the first plate 11 with a ferromagnetic element 14 of the array 16 associated with said strip 7, and
the coating material 33 coats the light source strips 7 and is in contact with the first plate 11 and the second plate 21. The material 33 is said to coat the strips 7 in that after the solidification of the material 33, it is no longer possible to extract the strips 7 from the material 33 without damaging said material 33.

The coating material 33 is designed to have a transmission coefficient of at least 80%, preferably at least 90%, of the light intensity of a wavelength emitted by each of the light sources 2, 12 of the strips 7.

The coating material comprises (preferably consists of) methyl methacrylate (MMA), but use could also be made of any resin or gel or liquid (epoxy, etc.) capable of being solidified by chemical catalysis, by heat, by electromagnetic radiation (for example UV radiation), etc. The problem with these resins, gels, or liquids is that they are often powerful solvents or at least that they interfere with the action of a glue, which makes the use of a standard solution such as an adhesive to hold the strips 7 in place problematic. According to the invention, use is thus made of magnetic forces to hold the strips in place before and during the solidification of the material 33.

It should furthermore be noted that the [method of the] invention is much more rapid and reliable than a method in which, for example, the guide would be cast between the two plates while disposing the light source strips gingerly and taking measures to position them precisely. Indeed, according to the invention and owing to the magnetic force connecting each pair of elements 14 and 24, each light source strip 7 almost completely alone positions itself in its proper position when it is disposed on the plate 11 roughly in proximity to the elements 14, which saves a considerable amount of time and ensures that the light sources are properly positioned.

The method according to the invention is also rapid because steps of filling the grooves can be dispensed with.

The method according to the invention is cost-effective because it requires a small amount of steps and labor.

With reference to FIG. 1, it is noted that in the method according to the invention, each light source strip 7 is disposed in such a way that its light sources 2, 12 are located between its circuit 10 and the first plate 11.

With reference to FIG. 1, it is noted that in the method according to the invention, each light source strip 7 is disposed in such a way that its ferromagnetic elements 24 are located between its circuit 10 and the first plate 11.

It is noted that each light source strip 7 comprises a reflective film 30 (for example, one made of two superimposed layers, each layer corresponding to a metallic or white reflective surface), on which the circuit 10 of this strip 7 is plated in such a way that said circuit 10 is located between the film 30 and the first plate 11. This film 30 comprises a metallic (e.g., tin) reflective surface and a white (e.g., white ink) reflective surface.

Each light source strip 7 is provided with a reflector 23 arranged to reflect light towards the first plate 11. This reflector 23 comprises a reflecting surface of the circuit 10 of this strip 7 and the metallic reflective surface of the reflector 30 oriented towards the first plate 11 and not hidden by the circuit 10, as illustrated in FIGS. 1 and 2.

Each light source strip 7 is provided with a reflector 13 arranged to reflect light towards the second plate 21. This reflector 13 comprises the white reflective surface of the reflector 30 oriented towards the second plate 21, as illustrated in FIGS. 1 and 2.

With reference to FIG. 1, each light source strip 7 is disposed in such a way that its circuit 10 is located in a plane 17 at a distance d (designated 8) from the first plate 11 less than its distance D (designated 18) from the second plate 21, preferably at least two times closer, preferably with:

$$d \leq \frac{D + d}{3}$$

(In a variant, each light source strip 7 is disposed in such a way that its circuit 10 is located in a plane 17 at a distance d (designated 8) from the first plate 11 very roughly equal to its distance D (designated 18) from the second plate 21, typically with:

$$\frac{1}{2} \leq \frac{D}{d} \leq 2 )$$

The first plate 11 comprises a first surface 6 in contact with the coating material 33 during the solidification thereof and a second surface 56 opposite the first surface 6.

Each ferromagnetic element 14 can (independently of the other elements 14):
be housed in the thickness of the first plate 11 by means of a tightening ring 27 (case of the arrays 16A, 16B, 16C illustrated in FIG. 1). This tightening ring 27 is typically made of a fluorocarbon polymer. This tightening ring 27 is made, for example, of polytetrafluoroethylene or Teflon®, polyethylene (PE), or polypropylene (PP). Each tightening ring 27 is clamped in a cavity 28. Each ferromagnetic element 14 is clamped in its ring 27. Hence with a play of two clamping forces exerted via a slightly flexible ring 27, each ferromagnetic element 14 can be secured in the plate 11 without using glue, which is advantageous in view of the aggressiveness of MMA or other similar materials on glue.
be located on the second surface 56 of the first plate 11 (by gluing, for example), without being in contact with either the coating material 33 as it solidifies or with a ferromagnetic element 24 as the coating material 33 is solidifying (case of the array 16D illustrated in FIG. 1; it should be noted that FIG. 1 illustrates two positions 14A and 14B of the element 14 for the array 16D: a position 14A in which the element 14 is on the second surface 56 of the first plate 11 without being pushed into said first plate 11, and a position 14B in which the element 14 is on the second surface 56 of the first plate 11 and pushed into said first plate 11). However, if this ferromagnetic element 14 is a magnet, it must be more powerful than if it was contained in the thickness of the first plate 11.

If housed in the thickness of the first plate 11, each ferromagnetic element 14 of said first plate 11 is:

in contact with the material 33 as it is solidifying, and

in contact with one of the elements 24 as the material 33 is solidifying.

If it is housed in the thickness of the first plate 11, each ferromagnetic element 14 of the first plate 11 can (independently of the other elements 14):
Extend beyond the surface 6 of the first plate 11 (case of the array 16C illustrated in FIG. 1), or
Not extend beyond the surface 6 of the first plate 11 (case of the arrays 16A, 16B illustrated in FIG. 1), which makes it easier to remove the guide 3 from the mold and avoids the need of having to fill the cavities dug by the elements 14 in the guide 3; in particular, each ferromagnetic element 14 of the first plate 11 can (independently of the other elements 14):
   be flush with the surface 6 of the first plate 11 (case of the array 16A illustrated in FIG. 1), or
   be located in a recess of the surface 6 of the first plate 11 (case of the array 16B illustrated in FIG. 1).

The ferromagnetic elements 14 of the first plate 11 illustrated in FIG. 1 are magnets, for example permanently magnetized magnets or electromagnets, preferably neodymium magnets.

The ferromagnetic element 24 associated with each element 14 can be a magnet or preferably be non-magnetized (which is more economical).

All of the ferromagnetic elements 14 of the same array 16 are preferably identical. In this case, all of the ferromagnetic elements 14 of the first plate 11 are preferably (but not necessarily, there can be differences among different arrays 16) identical.

All of the ferromagnetic elements 24 of the same strip 7 are preferably identical. In this case, all of the ferromagnetic elements 24 of the same light guide 3 are preferably (but not necessarily, there can be differences between different strips 7) identical.

Furthermore and in reference to FIGS. 5, 6, and 7, the first plate 11 is provided with sunken patterns 51, said patterns 51 being in contact with the coating material 33 as it is solidifying.

For each given array 16, starting from:
the projection of said array 16 on the surface 6 of the first plate 11 provided with sunken patterns 51,
in a direction of progression 9 or 19 perpendicular to the line 15 of said array 16,
   the surface density of the sunken patterns 51 per unit area (preferably initially zero on the line 15 of said array 16) increases progressively up to a certain limit distance 20, said limit distance preferably being equal to half of the distance 22 separating said given array 16 from its neighboring array 16 on the side of this direction of progression 9 (towards the right for the right neighbor) or 19 (towards the left for the left neighbor). The direction of progression 9 or 19 is preferably defined as being perpendicular to the tangent of the line 15 of said array 16. In this case and subsequently, unit area is understood to mean a typically square surface between 10 cm² and 20 cm² in area.

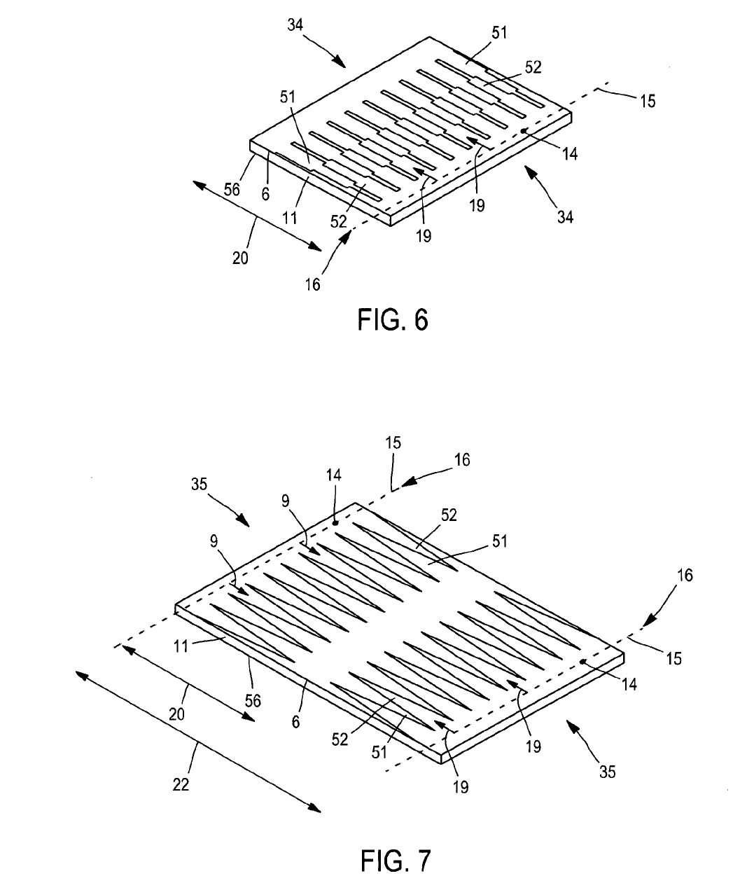

These patterns 51 can be dashes of increasing width in the direction 9 or 19 (FIG. 5), rectangles of successively increasing width in the direction 9 or 19 (FIG. 6), triangles widening in the direction 9 or 19 (FIG. 7), etc.

After the solidification of the coating material 33, a light guide 3 is obtained that comprises the solidified coating material 33 coating the at least one light source strip 7, said light guide 3 comprising a first surface 5 in contact the first plate 11 and a second surface 4 in contact with the second plate 21, and said light guide 3 is removed from the mold by extracting it from between the two plates 11, 21.

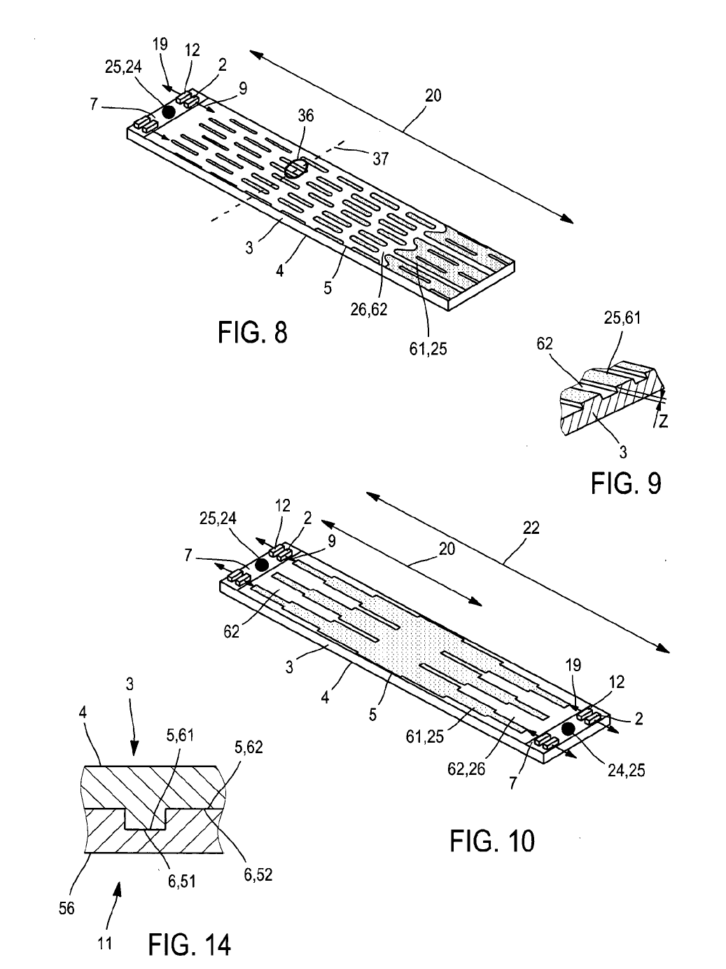

After demolding and in reference to FIGS. 8 through 12, a film (for example a 188 μm thick AMC C207W white adhesive film+a 42 μm thick acrylic layer) or any other reflective surface 25, 26 is glued onto the first surface 5 of the light guide 3 in such a way that said film or said reflective surface 25, 26 is only in contact with the portions 61 of the first surface 5 formed during the solidification of the coating material 33 in the sunken patterns 51 of the first plate 11.

A surface designed for reflecting light emitted by the light sources 2, 12 is designated as a reflective surface.

The reference signs 51, 52, 61, 62 are not illustrated in FIG. 1 so as not to overcrowd this figure.

With reference to FIG. 14, the reference sign 61 indicates the portions 61 of the first surface 5 of the guide 3 that were formed as the coating material 33 solidified in the sunken patterns 51 of the first plate 11.

With reference to FIG. 14, the reference sign 62 indicates the portions 62 of the first surface 5 of the guide 3 that were formed as the coating material 33 solidified on the non-sunken portions 52 of the surface 6 of the first plate 11, in other words outside the sunken patterns 51 of the first plate 11. The reference sign 62 therefore indicates the sunken patterns on the surface 5 of the guide 3, with a typical depth of between 0.1 and 1 mm.

The reference sign 25 indicates the portions of the reflective surface 25, 26 in contact with a ferromagnetic element 24 or with the first surface 5 (portion 61) of the guide 3. These portions 25 therefore do not have an intermediate space between the reflective surface 25, 26 and a ferromagnetic element 24 or the first surface 5 (portion 61).

The reference sign 26 indicates the portions 26 of the reflective surface 25, 26 not in contact with a ferromagnetic element 24 or with the first surface 5 of the guide 3. These portions 26 therefore have an intermediate space (typically an intermediate air space) between the reflective surface 25, 26 and a ferromagnetic element 24 or the first surface 5.

Hence for each given strip 7, starting from:
the projection of said strip 7 on the first surface 5 of the light guide, and
in a direction 9 or 19 perpendicular to the elongation of said strip 7, the density of the contact surface (preferably initially zero at the strip 7) between the surface 25, 26 and the first surface 5 of the guide 3 per unit area increases progressively up to a certain limit distance 20, said limit distance 20 preferably being equal to half of the distance 22 separating said strip 7 from its neighboring strip on the side of this direction 9 or 19.

The homogeneity of the diffusion of the light outside the guide 3 is thus improved.

In other words, a light guide 3 is obtained that comprises the coating material 33 coating the at least one strip 7 of light sources 2, 12 in such a way that, for each given light source strip 7, starting from:
the projection of said strip 7 on the first surface 5 of the light guide, and
in a direction of progression 9 or 19 perpendicular to the elongation of said strip 7,
   a surface density of sunken patterns 62 per unit area on this first surface 5 of the light guide 3 (preferably equal to one initially) decreases progressively up to a certain limit distance 20, said limit distance 20 preferably being equal to half of the distance 22 separating said given strip 7 from its neighboring strip 7 on the side of this direction of progression 9 or 19. The film or the reflective surface 25, 26 is glued onto the first surface 5 of the light guide 3 in such a way that said film or said reflective surface 25, 26 is only in contact with the non-sunken portions 61 of the first surface 5 of the guide 3.

Optionally and in the case of one or a plurality of ferromagnetic elements 24, as illustrated for the array 16B of FIG. 1 (i.e., for each element 24 that extends beyond or emerges from the surface 5, typically by 0.2 to 2 mm), in FIGS. 8, 10, and 11 it should be noted that each of these elements 24 serves as a support column for the reflective surface 25, 26; said columns 24 therefore being in contact with a portion 25 of the reflective surface 25, 26.

Lastly, to culminate the invention an apparatus is manufactured by integrating the light guide 3 in said apparatus in such a way that:
the first surface 5 of the light guide 3 is oriented towards the inside of the apparatus, and
the second surface 4 of the light guide is oriented towards the outside of the apparatus, preferably so that it is oriented towards a user located outside the apparatus; said second side 4 is not necessarily visible to the user because there may be an intermediate element (e.g., a screen, e.g., a liquid crystal (LCD) screen, a sign, a billboard, or a number plate) between the guide 3 and the user.

In a second embodiment of the invention, which shall only be described in terms of its differences from the first embodiment, with reference to FIG. 13 it should be noted that the lines 15 are not necessarily straight lines 15, but can be curved lines.

In addition and in contrast to what is illustrated in each of FIGS. 2 and 13, the lines 15 are not necessarily parallel in variants of these embodiments.

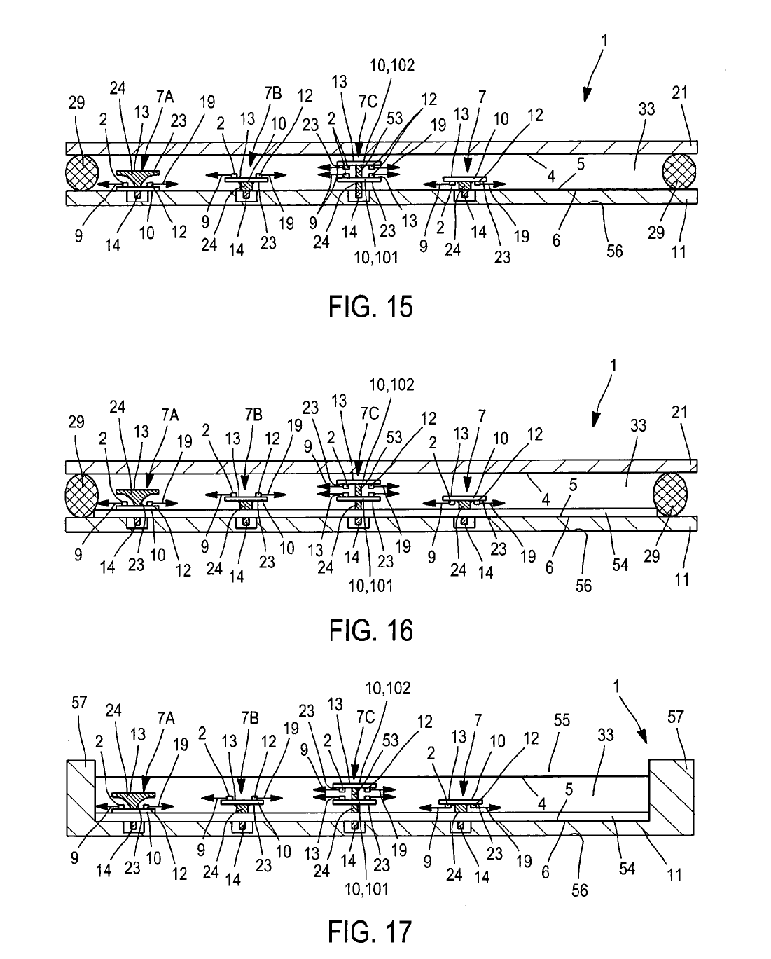

Furthermore and with reference to FIG. 15, there are variants of the embodiments that have just been described. In these variants, each strip 7 of FIG. 1 can be replaced with a strip 7A, 7B, or 7C of FIG. 15 combined with the different types of configurations of ferromagnetic elements 14 (arrays 16A, 16B, 16C and 16D) of the first plate illustrated in FIG. 1.

With respect to the light source strips 7 described with reference to FIG. 1, the light source strip 7A:

is disposed in such a way that its light sources 2, 12 are located between its circuit 10 and the second plate 21,

is disposed in such a way that its ferromagnetic elements 24 are located between its circuit 10 and the second plate 21,

has its elements 24, which are grouped in the form of a single longitudinal bar (extending perpendicularly to the plane of FIG. 15) provided with reflectors 13 and 23.

With respect to the light source strips 7 described with reference to FIG. 1, the light source strip 7B:

is disposed in such a way that its light sources 2, 12 are located between its circuit 10 and the second plate 21,

has its light sources 2, 12, which are borne on a side of the circuit 10 opposite the side of this same circuit 10 equipped with the elements 24 of said strip 7B.

With respect to the light source strips 7 described with reference to FIG. 1, the light source strip 7C is a “double” strip that comprises two circuits 101, 102.

The circuit 101:

is disposed in such a way that the light sources 2, 12 with which it is equipped are located between the circuit 101 and the second plate 21,

has its light sources 2, 12, which are borne on a side of the circuit 101 opposite the side of this same circuit 101 equipped with the elements 24 of said strip 7C.

The circuit 102:

is disposed in such a way that the light sources 2, 12 with which it is equipped are located between the circuit 101 and the second plate 21,

is disposed in such a way that the light sources 2, 12 with which it is equipped are located between the circuit 101 and the circuit 102,

is connected to the circuit 101 by one or a plurality of connecting elements 53 typically comprising metal pads welded onto each of the circuits 101 and 102.

Furthermore and with reference to FIG. 16, there are variants of the embodiments that have just been described wherein the first plate 11 is separated from the material 33 by one or a plurality of intermediate elements such as a plate 54 that is part of the manufactured guide 3, for example a polycarbonate or glass plate that can function as a diffuser or flame protectant for the material 33 (e.g., acrylic), which may be flammable (particularly in the case of the strips 7A, 7B, 7C, which each comprise a circuit that is equipped with light sources 2, 12 located between said circuit and the second plate 21).

Furthermore and with reference to FIG. 17, there are variants of the embodiments that have just been described wherein the second plate 21 is replaced with a free space 55, for example free air or any other kind of gaseous atmosphere. The casting is then effected simply by pouring the material 33 in a mold 1 comprising the first plate 11, which is thus preferably provided with rims 57.

Lastly and in a variant of everything described in the preceding, the use of “front view” light sources in lieu of “side view” light sources is possible, even if preference is given to the use of “side view”.

All of the variants described in the preceding can be combined with one another.

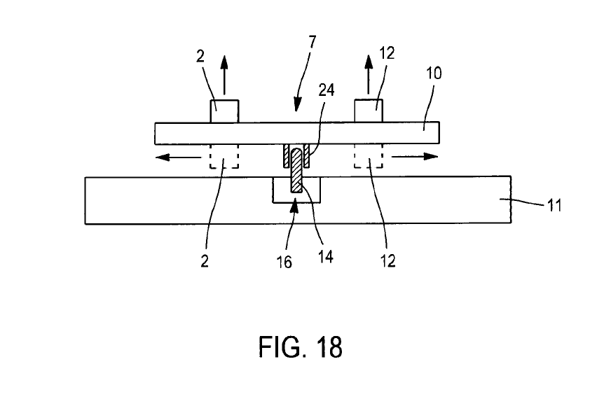

With reference to FIG. 18, it should be noted that according to the invention, all of the variants and all of the embodiments described can be generalized (regardless of whether the light sources 2, 12 are positioned below or above the circuit 10 or 101 or 102):
by replacing each (or just a portion of the) ferromagnetic element(s) 14 of the first plate 11 with a connecting element 14 comprising, for example, clipping or interlocking means or any other mechanical connection means, and
by replacing each (or just a portion of the) ferromagnetic securing element(s) 24 with a securing element 24 comprising, for example, clipping or interlocking means or any other mechanical means of complementary connection with a connecting element 14 of the first plate 11,
   such that each securing element 24 of a strip 7 is secured on the first plate 11 with a connecting element 14 of the array 16 associated with said strip 7, for example such that each mechanical securing element 24 of a strip 7 is mechanically secured on the first plate 11, preferably by clipping or interlocking, with a mechanical connecting element 14 of the array 16 associated with said strip 7.

Nevertheless it is true that the “ferromagnetic” embodiment is clearly preferred because:
it enables an “automatic” positioning of each element 14 with respect to an element 24 thanks to the magnetic attraction, which saves time and guarantees good reproducibility,
it makes the embodiments of FIGS. 16 and 17 possible,
it allows the possibility of having less precision in the spacing among the elements 24 themselves and/or among the elements 14 themselves.

Possibly in combination with the preceding generalization, it should be noted that according to the invention all of the variants and all of the embodiments described can be generalized:
by replacing each (or just a portion of the) array(s) 16 of connecting elements 14 by a group 16 of connecting elements 14 that are not necessarily aligned, and/or
by replacing each (or just a portion of the) strip(s) 7 of light sources 2, 12 with a sheet 7 of light sources 2, 12 that do not necessarily have an elongate strip shape, but can have a disc shape, for example, and/or
each sheet 7 or strip 7 of light sources 2, 12 can comprise a circuit 10 equipped with at least one securing element 24 and at least one light source 2, 12, i.e., in a minimum version equipped with a single securing element 24 and/or a single light source 2, 12, and/or
each group 16 of connecting elements can comprise at least one connecting element 14, i.e., a single securing element 14 in a minimum version.

In all of the variants and embodiments described in the preceding and in the case where the light sources 2, 12 comprise phosphorus, it is furthermore possible to reduce the risks of the phosphorus of the LED light sources 2, 12 being damaged by the coating material 33.

To this end, the light sources 2, 12 are coated with a UV-crosslinked acrylic resin.

This resin is composed of acrylate oligomers dissolved in one or a plurality of multifunctional acrylate diluents.

For example, use is made of at least one acrylate oligomer from among: polyester acrylates, epoxy acrylates, polyurethane acrylates.

These oligomers can be at least di-functional (at least 2 acrylate functions), even trifunctional, tetra-functional, penta-functional, etc.

Use is made of, for example, multifunctional monomers (as reactive diluents) of the general formula

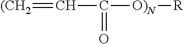

R is a group of atoms connected by bonds, preferably a carbon chain.

N is an integer greater than or equal to 2. When N=2, the monomer is a di-functional monomer.

When N=3, the monomer is a tri-functional monomer

When N=4, the monomer is a tetra-functional monomer

When N=5, the monomer is a penta-functional monomer

For example: HDDA=hexanediol diacrylate
with R=(CH₂)₆
and N=2

By manipulating the nature and quantity of the oligomers and/or diluents, the physico-chemical properties of the final polymer can be altered.

The other additives are mainly additives that generate radicals in the presence of UV rays or in an electron beam, e.g., benzophenones and derivatives thereof, and polymerization accelerators.

These radicals permit the opening of (preferably double) acrylate bonds and form various crosslinked oligomers.

For example, use is made of this formulation:
two acrylate oligomers, one of which is di-functional and the other tetra-functional: 20 to 50%
two reactive acrylate diluents, one of which is di-functional and the other tetra-functional: 20 to 50%
photoinitiator: 5%

The invention is obviously not limited to the examples that have just been described, and numerous adjustments may be made to these examples without exceeding the scope of the invention.

For example, to vary the density of the patterns 51, 62:
said patterns may be of constant size but distributed at variable intervals, or
said patterns may be of variable size but distributed at constant intervals.
   The various features, forms, variants, and embodiments of the invention can obviously be combined with one another in diverse ways as long as they are neither mutually incompatible nor mutually exclusive. All of the variants and embodiments described in the preceding can in particular be combined with each other.

1. A method for manufacturing a light guide in a mold, characterized in that the mold comprises:
a first plate provided with at least one group of connecting elements, each group of connecting elements comprising at least one connecting element, and a method wherein on said first plate:
the following are disposed:
at least one sheet of sources, each sheet of sources comprising a circuit that is equipped with at least one securing element and at least one light source, each sheet being associated with a group among the at least one group of connecting elements of the first plate, each sheet of sources being disposed such that each securing element of a sheet is secured on the first plate with a connecting element of the group associated with said sheet,
initially fluid coating material such that said fluid material coats the sheets of sources, and
wherein said coating material is then solidified.

2. The manufacturing method according to claim 1, characterized in that the at least one sheet of sources comprises at least one sheet of sources disposed such that the at least one light source thereof is located between the circuit thereof and the first plate.

3. The manufacturing method according to claim 1, characterized in that the at least one sheet of sources comprises at least one sheet of sources disposed such that the at least one connecting element thereof is located between the circuit thereof and the first plate.

4. The manufacturing method according to claim 1, characterized in that the at least one sheet of sources comprises at least one sheet of sources provided with a reflector arranged for reflecting light toward the first plate.

5. The manufacturing method according to claim 1, characterized in that the mold further comprises a second plate, the arrangement of the at least one sheet of sources and coating material on the first plate comprising an arrangement of the at least one sheet of sources and coating material between the first plate and the second plate, the at least one sheet of sources being disposed in such a way that its circuit is located in a plane that is closer, preferably at least three times closer, to the first plate than to the second plate.

6. The manufacturing method according to claim 1, characterized in that at least a portion of the at least one connecting element of the first plate is housed in the thickness of the first plate.

7. The manufacturing method according to claim 6, characterized in that each connecting element among at least a portion of at the least one of the connecting elements of the first plate is housed in the thickness of the first plate by means of a tightening ring.

8. The manufacturing method according to claim 1, characterized in that the first plate comprises a first surface that is in contact with the coating material during the solidification thereof and a second surface opposite the first surface, at least a portion of the at least one of the connecting elements of the first plate being located on the second surface of the first plate.

9. The manufacturing method according to claim 1, characterized in that each connecting element of the first plate is a magnet, for example a permanently magnetized magnet or an electromagnet.

10. The manufacturing method according to claim 1, characterized in that each connecting element of the at least one sheet of sources is not a magnet.

11. The manufacturing method according to claim 1, characterized in that the first plate is provided with sunken patterns, said patterns being in contact with the coating material as it is solidifying.

12. The manufacturing method according to claim 11, characterized in that, for each given group, in a direction of progression starting from this group the surface density of sunken patterns per unit area increases progressively up to a certain limit distance, said limit distance being preferably equal to half of the distance separating this given group from its neighboring group on the side of this direction of progression.

13. The manufacturing method according to claim 1, characterized in that, after the solidification of the coating material, a light guide is obtained that comprises the coating material coating the at least one sheet of sources, said light guide comprising a first surface in contact with the first plate and a second surface, and that this light guide is removed from the mold.

14. The manufacturing method according to claim 13, which is considered dependent on claim 11 or claim 12, characterized in that, after removal from the mold, a film is glued onto the first surface of the light guide in such a way that said film is only in contact with the portions of the first surface formed during the solidification of the coating material in the sunken patterns.

15. The manufacturing method according to claim 1, characterized in that:
each connecting element of each group is a ferromagnetic element,
each securing element of each sheet is a ferromagnetic securing element, such that each ferromagnetic securing element of a sheet is magnetically secured on the first plate with a ferromagnetic element of the group associated with said sheet.

16. The manufacturing method according to claim 1, characterized in that the at least one group of connecting elements consists of at least one array of connecting elements, each array of connecting elements comprising a plurality of connecting elements positioned along a line.

17. The manufacturing method according to claim 16, characterized in that the at least one array of connecting elements comprises at least one array of a plurality of connecting elements positioned along a straight line.

18. The manufacturing method according to claim 16, characterized in that the at least one array of connecting elements comprises a plurality of arrays positioned along parallel lines.

19. The manufacturing method according to claim 1, characterized in that the at least one sheet of sources consists of at least one strip of sources comprising a circuit equipped with at least one securing element and at least one light source.

20. The manufacturing method, according to claim 1, wherein the light guide is manufactured so that said light guide is integrated in an apparatus in such a way that the first surface of the light guide is oriented to the inside of the apparatus and that the second surface of the light guide is oriented to the outside of the apparatus.
